(19) United States
(12) Patent Application Publication
(10) Pub. No.: US 2023/0153833 A1
(43) Pub. Date: May 18, 2023

(54) SYSTEMS AND METHODS FOR DETECTING ANOMALOUS ACTIVITY OVER A COMPUTER NETWORK

(71) Applicant: MASTERCARD INTERNATIONAL INCORPORATED, Purchase, NY (US)

(72) Inventors: Brett J. Thomson, Lake Saint Louis, MO (US); Kyle Williams, Wentzville, MO (US); David J. Senci, Troy, IL (US)

(21) Appl. No.: 18/151,405

(22) Filed: Jan. 6, 2023

Related U.S. Application Data
(63) Continuation of application No. 17/065,336, filed on Oct. 7, 2020.

(51) Int. Cl. G06Q 30/018; G06Q 40/02; G06Q 20/34; G06Q 20/40; G08B 13/22; H04L 9/40; G06F 16/23; G06N 20/00; G06F 16/22

(52) U.S. Cl. CPC G06Q 30/0185; G06Q 40/02; G06Q 20/34; G06Q 20/4016; G08B 13/22; H04L 63/1416; G06F 16/2379; G06N 20/00; G06F 16/22

(57) ABSTRACT

Computing systems and methods for detecting anomalous activity over a computer network are described herein. A computing system receives a real-time stream of electronic messages, each of the electronic messages including a first identifier, wherein a portion of the first identifier includes a second identifier. The computing system applies a detection model to the real-time stream of electronic messages, wherein the detection model is programmed to apply at least one machine learning algorithm trained to detect that a velocity of the electronic messages for a range of first identifiers having a common value second identifier exceeds a threshold. In response to the threshold being exceeded, a time period associated with anomalous activity is identified and an anomalous activity flag is appended to messages initiated during the time period associated with anomalous activity which include a first identifier having the common value in the second identifier.

### CROSS REFERENCE TO RELATED APPLICATIONS

This application is a continuation of and claims priority to U.S. patent application Ser. No. 17/065,336, filed on Oct. 7, 2020, the entire contents of which are hereby incorporated by reference in their entirety.

### BACKGROUND

This disclosure relates generally to detecting anomalous activity over a computer network and, more particularly, to systems and methods for detecting anomalous activity of computer messages transmitted in real-time over a computer network.

Payment processing networks process numerous payment card transactions every day that are initiated by cardholders of payment cards. Most of these payment card transactions are valid transactions. However, at least some of these payment card transactions are fraudulent. In particular, one type of “fraud attack” includes fraudsters attempting fraudulent transactions using a Bank Identification Number (BIN), which is frequently the first six digits of a payment card number. The fraudsters attempt to identify valid payment card information by repetitively cycling through potential payment card numbers using the same BIN (i.e., iterating through different combinations of ten digits following the BIN).

Payment card transaction processors, such as payment networks and issuing banks, may monitor payment card transactions for signs of fraudulent activity. At least some known fraud detection systems monitor payment card transactions one payment card transaction at a time to determine whether the payment card transaction is potentially fraudulent. Such systems may not be able to detect certain types of widespread fraud attacks, such as the above-described common BIN fraud attacks. Moreover, these systems lack processes and infrastructure to effectively respond to these BIN attacks.

### BRIEF DESCRIPTION

In one embodiment, a computing system for detecting account range fraud attacks on a payment card network is provided. The computing system includes an attack detection and response (ADR) computing device configured to detect an occurrence of an account range fraud attack in which a set of primary account numbers (PANs), each associated with a respective payment card, that share a common bank identification number (BIN) are subject to potential fraud, retrieve a plurality of transaction records associated with a respective plurality of transactions initiated during a time period associated with the fraud attack, and, for each transaction of the plurality of transactions, determine an issuer response that indicates whether the respective transaction was authorized or declined. The ADR computing device is also configured to, for each authorized transaction, extract the PAN from the transaction record associated with the respective authorized transaction, identify a respective issuer of the payment card associated with each extracted PAN, and transmit a fraud attack alert to each identified issuer. The fraud attack alert identifies the fraud attack, the time period associated with the fraud attack, and the PANs associated with the authorized transactions, and the fraud attack alert causes the issuer to record the PANs as compromised.

In another embodiment, a computer-implemented method for detecting account range fraud attacks on a payment card network is provided. The method is implemented using an attack detection and response (ADR) computing device including a memory and a processor. The method includes detecting an occurrence of an account range fraud attack in which a set of primary account numbers (PANs), each associated with a respective payment card, that share a common bank identification number (BIN) are subject to potential fraud, retrieving a plurality of transaction records associated with a respective plurality of transactions initiated during a time period associated with the fraud attack, and, for each transaction of the plurality of transactions, determining an issuer response that indicates whether the respective transaction was authorized or declined. The method also includes, for each authorized transaction, extracting the PAN from the transaction record associated with the respective authorized transaction, identifying a respective issuer of the payment card associated with each extracted PAN, and transmitting a fraud attack alert to each identified issuer. The fraud attack alert identifies the fraud attack, the time period associated with the fraud attack, and the PANs associated with the authorized transactions, and the fraud attack alert causes the issuer to record the PANs as compromised.

In yet another embodiment, a non-transitory computer-readable storage medium including computer-executable instructions stored thereon is provided. When executed by an attack detection and response (ADR) computing device including a processor and a memory, the computer-executable instructions cause the processor to detect an occurrence of an account range fraud attack in which a set of primary account numbers (PANs), each associated with a respective payment card, that share a common bank identification number (BIN) are subject to potential fraud, retrieve a plurality of transaction records associated with a respective plurality of transactions initiated during a time period associated with the fraud attack, and, for each transaction of the plurality of transactions, determine an issuer response that indicates whether the respective transaction was authorized or declined. The computer-executable instructions also cause the processor to, for each authorized transaction, extract the PAN from the transaction record associated with the respective authorized transaction, identify a respective issuer of the payment card associated with each extracted PAN, and transmit a fraud attack alert to each identified issuer. The fraud attack alert identifies the fraud attack, the time period associated with the fraud attack, and the PANs associated with the authorized transactions, and the fraud attack alert causes the issuer to record the PANs as compromised.

### BRIEF DESCRIPTION OF THE DRAWINGS

FIGS. 1-5 show example embodiments of the methods and systems described herein.

FIG. 1 is a simplified block diagram of an example fraud analysis computing system for detecting and responding to account range fraud attacks on a payment card network, in accordance with one example embodiment of the present disclosure.

FIG. 2 is a simplified flow diagram illustrating a fraud attack response process implemented using the fraud analysis computing system shown in FIG. 1.

FIG. 3 illustrates an example configuration of a server system that may be used in the fraud analysis computing system shown in FIG. 1.

FIG. 4 illustrates an example configuration of a client system that may be used in the fraud analysis computing system shown in FIG. 1.

FIG. 5 is a flow diagram of a computer-implemented method for detecting account range fraud attacks on a payment card transaction network.

### DETAILED DESCRIPTION

Embodiments of the present disclosure describe a fraud analysis computing system, and methods implemented using such a computing system. The fraud analysis computing system is configured to identify fraud attacks that occur on a larger scale, such as BIN attacks, rather than individual transactions. A BIN attack is also referred to herein as an account range fraud attack, because a BIN defines a set of account numbers that share a common BIN. An account range may include primary account numbers (PANs) associated with a BIN of a particular issuer, or a subset of PANs associated with the particular issuer, for example, within a particular geographic region. A BIN attack may also be referred to as an account- or card-testing attack, because a fraudster “tests” many numbers in an attempt to find a valid account or card (e.g., debit card, credit card, etc.) number.

As described above, during a BIN attack, a fraudster attempts to initiate transactions using many “hypothetical” primary account numbers (PANs, which may include credit card or debit card numbers), using a single BIN (e.g., a leading six digits of a PAN) and iterations (random or sequential) of the rest of the digits that form the PAN (e.g., the final ten digits). In at least some cases, the fraudster uses computer programs to generate the hypothetical or “test” PANs, and/or to cycle through various uses of a same PAN with different “test” expiration dates and/or security codes associated with PANs that are typically required to successfully initiate a transaction. The fraudster may use a single merchant (e.g., a payment portal for an online merchant) for these tests or may be making the transaction attempts across many online merchants.

Many of these attempted transactions are met with declines, because the PAN does not exist or is invalid and/or the fraudster has failed to provide additional information (e.g., a correct expiration date and/or security code). However, at least some of these attempted transactions are approved by the issuer.

One example BIN attack is illustrated as follows. In this example, a fraudster conducts a BIN attack using PANs sharing a common BIN 123456 at an example merchant XYZ Company. The fraudster attempts a low-cost purchase to avoid fraud detection associated with high transaction amounts, and as such attempts to “check out” with a $1.00 purchase at a purchase portal with XYZ Company. During the checkout process, the fraudster attempts to complete the purchase with the results as follows:

Attempt 1: 123456—next 10 digits are 1234567890 Issuer Declines

Attempt 2: 123456—next 10 digits are 1234567891 Issuer Declines

Attempt 3: 123456—next 10 digits are 1234567892 Issuer Approves

Attempt 4: 123456—next 10 digits are 1234567893 Issuer Declines

Attempt 5: 123456—next 10 digits are 1234567894 Issuer Approves

These issuer approvals indicate to the fraudster that they have discovered a valid PAN that can be used for subsequent fraud. For the numbers that resulted in an Issuer Approval, the fraudster may sell these PANs on the black market or attempt to use them in follow-up attempts for larger purchases. It is readily apparent that these BIN attacks not only may compromise any number of PANs within a targeted account range, but that these repeated transaction attempts place a heavy network load on a processing network used (by the merchant) to initiate these attempted transactions.

The fraud analysis computer system described herein is configured to monitor transaction streams to detect BIN attacks. In the example embodiment, the fraud analysis computer system is associated with and/or integral to a payment processing network, such that the fraud analysis computer system may monitor real-time transaction streams (i.e., as the transactions are being processed over the payment processing network). Additionally or alternatively (e.g., where the fraud analysis computer system is not associated with and/or integral to the payment processing network), the methods described herein may be applied to stored transaction records to perform fraud analysis at a later time.

In particular, the fraud analysis computer system includes an attack detection and response (ADR) computing device configured to monitor the transaction streams using artificial intelligence and/or machine learning algorithms to detect a BIN attack. The artificial intelligence and/or machine learning algorithms may include one or more detection models trained to identify anomalously high levels of transaction traffic for a common account range or BIN. In particular, a standard or expected velocity associated with any BIN may be pre-defined, stored, and provided to the detection models. These standard velocities may be determined and pre-defined based upon analysis of a plurality of historical transactions (e.g., hundreds, thousands, tens of thousands, hundreds of thousands, etc., of historical transactions) initiated using PANs sharing a same BIN.

As the detection models are applied to the real-time transaction streams, these models detect anomalously high BIN velocities (i.e., levels of transaction traffic) as BIN velocities that exceed a pre-defined threshold level above a standard velocity for a BIN. For example, the pre-defined threshold level may include one or two standard deviations above the standard BIN velocity, a particular percentage higher (e.g., 100%, 200%, 500%) than a standard BIN velocity, and the like. It should be understood that standard BIN velocities may not be a stagnant value but may fluctuate based upon various factors, such as a date, season, and the like. For example, most standard BIN velocities may increase during a time of year when purchase levels increase (e.g., around Christmas or other major holidays).

In some embodiments, the detection models also monitor velocities for BIN-merchant pairs, which may enable more precise BIN attack monitoring and/or detection. The detection models may monitor the transaction streams for anomalously high BIN-merchant velocities, in which an anomalously high number of transactions are attempted at a single merchant (e.g., BIN-merchant velocities that exceed a pre-defined threshold level, such as one or two standard deviations above a standard velocity or a percentage higher than a standard velocity). These events may be even more strongly indicative of a BIN attack than only monitoring BIN velocities.

Additionally or alternatively, the detection models monitor the transaction streams for anomalously high PAN velocities (e.g., PAN velocities that exceed a pre-defined threshold level, such as one or two standard deviations above a standard velocity or a percentage higher than a standard velocity). Specifically, where a same PAN is used to attempt an anomalously high number of transactions, including transactions attempted with varying (e.g., sequential or random) expirations dates and/or security codes, a BIN attack (e.g., a card- or account-testing attack) may be occurring.

For any of these velocities, the detection models may be further trained to identify anomalously high velocities accompanied by anomalously high numbers of declines relative to approvals/authorizations. As described above, BIN attacks are characterized by repeated transaction attempts that frequently result in declines (due to invalid PANs, expiration dates, and/or security codes being provided). Accordingly, high velocity accompanied by a high level of declines or high ratios of declines to approvals (e.g., one or two standard deviations above a standard value or a percentage above a standard value) may be more strongly indicative of a BIN attack.

It is also contemplated that account status inquiries (ASIs) may also be monitored for BIN attack behavior, such as repeated ASIs for a same PAN with varying expiration dates and/or security codes, or anomalously high ASI traffic (velocity) for a particular BIN.

In some embodiments, when a BIN attack is detected, the ADR computing device may identify a targeted BIN associated with the BIN attack—that is, a BIN common to PANs being used in attempted transactions—and/or a merchant (or merchants) being used to implement the BIN attack. In some such embodiments, where the BIN attack is ongoing or current, the ADR computing device may cause all transactions with the BIN and/or at the merchant(s) to be declined for a period of time (e.g., minutes, hours, etc.), to disrupt the ongoing BIN attack. The ADR computing device may take other steps, such as notifying issuers, cardholders/accountholders, and/or law enforcement parties of the BIN attack.

In addition, when a BIN attack is detected (either an ongoing BIN attack or a previous BIN attack detected at a later time), the ADR computing device is configured to retrieve all transactions that may be associated with the BIN attack. Specifically, the ADR computing device identifies a time period associated with the BIN attack. The time period may begin at a time when a first transaction that is determined to likely be associated with the BIN attack was attempted. This first transaction may be the first attempted transaction at the merchant identified as associated with the BIN attack, or a first transaction with a common BIN attempted at the start of the BIN attack associated with that common BIN. Alternatively, the time period may begin at some time before an identified first transaction (e.g., five minutes, ten minutes, one hour before, etc.), under the presumption that one or more transactions associated with the BIN attack may have been attempted but not necessarily individually detected.

Retrieving transactions associated with a BIN attack may include retrieving transaction records (e.g., authorization messages or records thereof) associated with those attempted transactions. In some embodiments, when the BIN attack is detected, the ADR computing device appends a flag (e.g., an “attack identifier flag”) to the transaction records of the transactions associated with the BIN attack (e.g., initiated during the time period associated with the BIN attack). The attack identifier flag may be an alphanumeric code generally associated with BIN attacks or unique to this particular BIN attack. Additionally or alternatively, the attack identifier flag may be a binary value that is changed from 0 to 1—where 0 (previously) indicated a transaction record was not associated with any fraud or, more particularly, not associated with a BIN attack, and where 1 indicates that transaction record is now associated with fraud or, more particularly, is associated with a BIN attack.

The ADR computing device may append the attack identifier flag to all transaction records of transactions initiated during the time period associated with the BIN attack. Alternatively, the ADR computing device may, after identifying the specific BIN being targeted in the BIN attack, append the attack identifier flag only to transaction records having PANs that include the identified targeted BIN.

The ADR computing device determines, for each of the transactions initiated or attempted during the time period associated with the BIN attack, a respective issuer response. The issuer response may be an authorization, indicating that the attempted transaction was successfully authorized, such as a response field populated with a “00” data element. The issuer response may otherwise be a decline, indicating that the attempted transaction was not authorized (e.g., due to an invalid PAN, expiration date, and/or security code). Each authorization indicates that the fraudster was successful in an attempted transaction, which in turn indicates that the PAN associated with the authorization may be compromised and vulnerable to future fraud attempts.

Accordingly, the ADR computing device extracts a PAN from each transaction record associated with an authorized transaction. These PANs are considered compromised as successfully “tested” by fraudsters. The ADR computing device generates a fraud attack alert that includes all of these compromised PANs and transmits the fraud attack alert to the issuer (or, in some cases, issuers) of the compromised PANs. In the example embodiment, the fraud attack alert includes instructions that cause the issuer to record or flag all of the PANs identified in the fraud attack alert as compromised or potentially compromised. Accordingly, any time a compromised/potentially compromised PAN is used to initiate a future or subsequent transaction, that transaction will undergo enhanced authentication before being authorized. Enhanced authentication may include, for example, two-factor authentication that requires an additional authentication data element be provided by a user that initiated the transaction, such as a one-time password, biometric sample, and the like. This enhanced authentication requirement imposed on the compromised/potentially compromised PAN enables a true cardholder (or other user of the payment card) to continue using the same PAN while preventing fraudulent use thereof.

Additionally or alternatively, the flag may cause the issuer to increase a fraud score for any future or subsequent transaction initiated using a compromised PAN. The increased fraud score may, in some cases, not automatically trigger enhanced authentication or may trigger varying levels of enhanced authentication.

In some embodiments, the fraud attack alert additionally or alternatively includes instructions that cause the issuer to initiate a process for generating and providing new PANs to replace the compromised PANs. Because this process may not be immediate, the flagged PANs may be used (subject to the enhanced authentication described above) before the new PAN is issued.

In some embodiments, the fraud attack alert includes additional information, such as more details associated with the particular BIN attack. For example, the fraud attack alert may include the time period associated with the BIN attack. As another example, the fraud attack alert may identify the one or more merchants at which the BIN attack was implemented. The issuer may choose to implement additional authentication procedures for any future transaction initiated at these merchants.

In some embodiments, the ADR computing device transmits the fraud attack alert, or an alternative alert message, to cardholders or accountholders associated with the compromised PANs. In some such embodiments, the cardholders/accountholders may decide whether to prompt their issuer to issue a new PAN or whether to impose the enhanced authentication requirement on the compromised PAN. Accordingly, the ADR computing device may receive user input indicating a user selection of how the issuer is to proceed, and may transmit instructions to the issuer that cause the issuer to implement the user selection.

In at least some embodiments, the ADR computing device monitors compromised PANs and/or performs enhanced authentication on behalf of the issuer. Specifically, the ADR computing device may store the PANs in a compromised account database. Only compromised PANs are stored in this compromised account database. Accordingly, the ADR computing device monitors all incoming transaction messages (e.g., authorization request messages and/or authentication request messages), extracts a subject PAN from each incoming transaction message, and performs a lookup in the compromised account database using the subject PAN. If the subject PAN matches any PAN stored in the compromised account database, the ADR computing device may flag the incoming transaction message with a compromise flag before transmitting the transaction message to the issuer. The compromise flag causes the issuer to automatically initiate enhanced authentication of the associated transaction. Additionally or alternatively, the ADR computing device automatically performs the enhanced authentication on behalf of the issuer, and transmits the transaction message to the issuer appended with (a) the compromise flag, and (b) the authentication result of the enhanced authentication, such that the issuer may use the compromise flag and/or authentication result to determine whether to authorize the transaction. In some cases, the issuer may use these data elements in its own authentication procedures or, where the authentication result indicates the transaction is likely genuine, may forego its own authentication procedures. Moreover, it is contemplated that, in some embodiments, the ADR computing device may decline (or cause to be declined) any transaction message associated with a compromised PAN.

In some alternative embodiments, the ADR computing device stores the compromised PANs in a more general account database that includes both compromised and non-compromised PANs (e.g., with various flags indicating various characteristics of associated PANs). In such cases, the ADR computing device may store the compromised PANs with a compromise flag indicating the PANs are compromised. The ADR computing device monitors all incoming transaction messages (e.g., authorization request messages and/or authentication request messages), extracts a subject PAN from each incoming transaction message, and performs a lookup in the account database using the subject PAN. Where the subject PAN matches a PAN with the compromise flag, the ADR computing device may initiate enhanced authentication and/or append the compromise flag to the transaction message as described above.

In some embodiments of the present disclosure, the ADR computing may store all PANs having the attack identifier flag, described above, in the general account database. In some such cases, the ADR computing device may monitor all incoming transaction messages (e.g., authorization request messages and/or authentication request messages), extract a subject PAN from each incoming transaction message, and perform a lookup in the account database using the subject PAN. Where the subject PAN matches a PAN with the attack identifier flag (but not the compromise flag), the ADR computing device may append a different flag to that transaction message, instructing the issuer to raise the fraud score for that transaction message, but not necessarily requiring initiation of the enhanced authentication. In this way, any valid PAN that was for whatever reason used unsuccessfully during a BIN attack may still be subject to increased scrutiny when used in subsequent transactions, to prevent additional fraud.

The technical problems addressed by this system include at least one of: (i) undetected network-based fraud events on a payment card transaction network, especially those targeted at accounts issued by a specific issuer and/or within a certain account range; (ii) increased network load from account range fraud attacks that include numerous repeated transaction attempts within short periods of times; (iii) increased network usage (slowing down the network) due to undetected frauds (e.g., systematic attacks to determine card verification numbers through trial and error); and/or (iv) inability to detect and/or respond to account range fraud attacks, in particular, to detect and/or respond to account range fraud attacks in real-time.

The methods and systems described herein may be implemented using computer programming or engineering techniques including computer software, firmware, hardware, or any combination or subset thereof, wherein the technical effects may be achieved by performing at least one of the following steps: (a) detecting an occurrence of an account range fraud attack in which a set of primary account numbers (PANs), each associated with a respective payment card, that share a common bank identification number (BIN) are subject to potential fraud; (b) retrieve a plurality of transaction records associated with a respective plurality of transactions initiated during a time period associated with the fraud attack; (c) for each transaction of the plurality of transactions, determine an issuer response that indicates whether the respective transaction was authorized or declined; (d) for each authorized transaction of the plurality of transactions, extract the PAN from the transaction record associated with the respective authorized transaction; (e) identify a respective issuer of the payment card associated with each extracted PAN; and (f) transmit a fraud attack alert to an issuer of the extracted PANs, the fraud attack alert identifying the fraud attack, the time period associated with the fraud attack, and the PANs associated with the authorized transactions, wherein the fraud attack alert causes the issuer to record the PANs as compromised.

The resulting technical effect achieved by this system is at least one of: (i) reducing network-based fraud events through early detection, in particular, real-time detection (and, therefore, real-time response to) account-range fraud attacks; (ii) reducing future fraud events by flagging compromised accounts/account numbers; (iii) applying artificial intelligence and/or machine learning algorithms to monitor a variety of velocities to accurately and robustly detect account range fraud attacks; and/or (iv) alerting affected parties to fraud attacks to facilitate increased fraud prevention. Thus, the system enables enhanced fraud detection on the payment card transaction network. Once a pattern of fraudulent activity is detected and identified, further fraudulent payment card transaction attempts may be reduced or isolated from further processing on the payment card interchange network, which results in a reduced amount of fraudulent network traffic and reduced processing time devoted to fraudulent transactions, and thus a reduced burden on the network.

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

As used herein, a “processor” may include any programmable system including systems using central processing units, microprocessors, micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

The systems and processes are not limited to the specific embodiments described herein. In addition, components of each system and each process can be practiced independent and separate from other components and processes described herein. Each component and process can also be used in combination with other assembly packages and processes.

As used herein, the terms “transaction card,” “financial transaction card,” and “payment card” refer to any suitable payment card, such as a credit card, a debit card, a prepaid card, a charge card, a membership card, a promotional card, a frequent flyer card, an identification card, a prepaid card, a gift card, and/or any other payment device that may hold payment account information, such as mobile phones, Smartphones, personal digital assistants (PDAs), key fobs, and/or computers. Each type of payment device can be used as a method of payment for performing a transaction.

As used herein, the term “real-time” is used, in some contexts, to refer to a regular updating of data within a system such as payment processing networks and/or fraud detection systems. When a system is described as processing or performing a particular operation “in real-time,” this may mean within seconds or minutes of an occurrence of some trigger event, such as new data being generated (e.g., an incoming transaction message being received), or on some regular schedule, such as every minute. In other contexts, some payment card transactions require “real-time” fraud operations, such as fraud scoring, which refers to operations performed during authorization of a payment card transaction (i.e., between the moment that a new payment card transaction is initiated from, for example, a merchant, and the time that an authorization decision is made, for example, back to that merchant). In such a context, “near real-time” fraud operations are operations conducted shortly after the payment card transaction has been initiated.

The following detailed description illustrates embodiments of the disclosure by way of example and not by way of limitation. It is contemplated that the disclosure has general application to fraud detection and prevention for payment card transactions.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

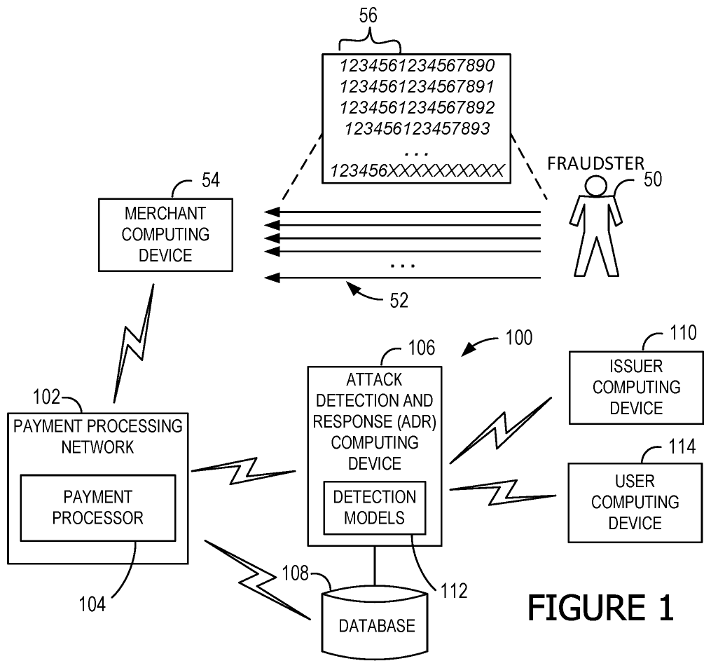

FIG. 1 is a schematic block diagram of a fraud analysis computing system 100 for detecting account range fraud attacks in a payment card network, such as payment card interchange network or payment processing network 102. For example, fraudsters 50 may attempt numerous fraudulent transactions 52 through a merchant 54, such as an account range fraud attack, as described above in greater detail. Fraudulent transactions may strain the processing and network resources of payment processing network 102. For example, these account range fraud attacks include a large number of attempted online transactions 52 in a short period of time, which may limit a bandwidth of payment processing network 102 that is available for legitimate transactions. Moreover, fraudulent transactions that are not detected prior to authorization may result in additional activity over payment processing network 102 such as voids, rollbacks of cleared and settled transactions, and so forth, which may reduce processing speed and bandwidth available for legitimate transactions.

In the example embodiment, fraud analysis computing system 100 includes payment processing network 102, which itself includes a plurality of payment processors 104, as well as an attack detection and response (ADR) computing device 106 communicatively coupled to payment processing network 102 and to one or more databases 108. In some embodiments, as noted above, ADR computing device 106 is implemented as part of, or in association with, payment processing network 102. Payment processing network 102 may include any transaction processing network, scheme, or system suitable for processing online transactions, including payment card (e.g., credit card, debit card, prepaid card, etc.) transactions, such as the Mastercard® interchange network. The Mastercard® interchange network is a set of proprietary communications standards promulgated by Mastercard International Incorporated® for the exchange of financial transaction data and the settlement of funds between financial institutions that are members of Mastercard International Incorporated®. (Mastercard is a registered trademark of Mastercard International Incorporated located in Purchase, N.Y.).

In a typical payment card system, an issuer (represented in FIG. 1 as an issuer computing device 110) issues a payment card, such as a credit card, to a consumer or cardholder (not shown), who uses the payment card to tender payment for a purchase from merchants. During fraudulent transactions, a primary account number (PAN) associated with the payment card may be fraudulently provided (e.g., by a fraudster) to initiate the transaction without the knowledge and/or consent of the cardholder. When the PAN is used to initiate a transaction with a merchant, the merchant requests authorization from their own merchant bank for the amount of the purchase. Using payment processing network 102, computers of the merchant bank will communicate with issuer computing device 110 by sending a payment card transaction authorization request. Based on the payment card transaction authorization request, issuer computing device 110 determines whether the account associated with the PAN is in good standing and whether the purchase is covered by an available credit line. Issuer computing device 110 may additionally perform one or more authentication procedures to determine whether the transaction is genuine or legitimate (i.e., initiated by the cardholder). Based on these determinations, the request for authorization will be declined or accepted/authorized.

In the example embodiment, payment processing network 102 may route incoming or current payment card transaction authorization requests in real-time through ADR computing device 106, as described above. Additionally or alternatively, payment processing network 102 may store records of the authorization requests in database 108, and ADR computing device 106 may retrieve and analyze the stored records for fraud (e.g., BIN attacks) at a later time.

ADR computing device 106 is configured to monitor transaction streams (e.g., transaction messages processed over payment processing network 102, such as authorization request messages and/or account status inquiries) using artificial intelligence and/or machine learning algorithms to detect a BIN attack. The artificial intelligence and/or machine learning algorithms may include one or more detection models 112 trained to identify anomalously high levels of transaction traffic in a common account range or with a common BIN (e.g., a common BIN 56). In particular, a standard or expected velocity associated with any BIN may be pre-defined, stored (e.g., in database 108), and provided to detection models 112. These standard velocities may be determined and pre-defined based upon analysis of a plurality of historical transactions (e.g., hundreds, thousands, tens of thousands, hundreds of thousands, etc., of historical transactions) initiated using PANs sharing a same BIN.

As detection models 112 are applied to the real-time transaction streams, these models 112 detect one or more of anomalously high BIN velocities, anomalously high BIN-merchant velocities, anomalously high PAN velocities, and/or anomalously high numbers of declines relative to approvals/authorizations, as described above.

In some embodiments, when a BIN attack is detected by detection models 112, ADR computing device 106 may identify a targeted BIN associated with the BIN attack—that is, a BIN common to PANs being used in attempted transactions—and/or merchant 54 (or multiple merchants 54) being used to implement the BIN attack. In some such embodiments, where the BIN attack is ongoing or current, ADR computing device 106 may cause all transactions with the BIN and/or at merchant(s) 54 to be declined for a period of time (e.g., minutes, hours, etc.), to disrupt the ongoing BIN attack. ADR computing device 106 may take other steps, such as notifying issuers, cardholders/accountholders, and/or law enforcement parties of the BIN attack.

In addition, when a BIN attack is detected (either an ongoing BIN attack or a previous BIN attack detected at a later time), ADR computing device 106 is configured to retrieve all transactions that may be associated with the BIN attack. Specifically, ADR computing device 106 identifies a time period associated with the BIN attack and retrieves transactions initiated during that time period. In some embodiments, when the BIN attack is detected, ADR computing device 106 appends an attack identifier flag to the transaction records of the transactions associated with the BIN attack (e.g., initiated during the time period associated with the BIN attack). ADR computing device 106 may append the attack identifier flag to all transaction records of transactions initiated during the time period associated with the BIN attack. Alternatively, ADR computing device 106 may, after identifying the specific BIN being targeted in the BIN attack, append the attack identifier flag only to transaction records having PANs that include the identified targeted BIN.

ADR computing device 106 determines, for each of the transactions initiated or attempted during the time period associated with the BIN attack, a respective issuer response. The issuer response may be an authorization, indicating that the attempted transaction was successfully authorized by issuer computing device 110, such as a response field populated with a “00” data element. The issuer response may otherwise be a decline, indicating that the attempted transaction was not authorized (e.g., due to an invalid PAN, expiration date, and/or security code) by issuer computing device 110. Each authorization indicates that the fraudster was successful in an attempted transaction, which in turn indicates that the PAN associated with the authorization may be compromised and vulnerable to future fraud attempts.

Accordingly, ADR computing device 106 extracts a PAN from each transaction record associated with an authorized transaction. ADR computing device 106 generates a fraud attack alert that includes all of these compromised PANs and transmits the fraud attack alert to one or more issuer computing devices 110 of the one or more issuers of the compromised PANs. In the example embodiment, the fraud attack alert includes instructions that cause issuer computing device(s) 110 to flag all of the PANs identified in the fraud attack alert as compromised. Accordingly, any time a compromised PAN is used to initiate a future or subsequent transaction, that transaction will undergo enhanced authentication before being authorized. Additionally or alternatively, the flag may cause issuer computing device 110 to increase a fraud score for any future or subsequent transaction initiated using a compromised PAN. The increased fraud score may, in some cases, not automatically trigger enhanced authentication or may trigger varying levels of enhanced authentication.

In some embodiments, the fraud attack alert additionally or alternatively includes instructions that cause issuer computing device 110 to initiate a process for generating and providing new PANs to replace the compromised PANs. Because this process may not be immediate, the flagged PANs may be used (subject to the enhanced authentication described above) before the new PAN is issued.

In some embodiments, the fraud attack alert includes additional information, such as more details associated with the particular BIN attack. For example, the fraud attack alert may include the time period associated with the BIN attack. As another example, the fraud attack alert may identify the one or more merchants 54 at which the BIN attack was implemented. Issuer computing device 110 may choose to implement additional authentication procedures for any future transaction initiated at these merchants 54.

In some embodiments, ADR computing device 106 transmits the fraud attack alert, or an alternative alert message, to cardholders or accountholders associated with the compromised PANs. Specifically, ADR computing device 106 may transmit the fraud attack alert to a user computing device 114 associated with a respective cardholder/accountholder. In some such embodiments, the cardholders/accountholders may decide whether to prompt their issuer to issue a new PAN or whether to impose the enhanced authentication requirement on the compromised PAN. Accordingly, ADR computing device 106 may receive user input from user computing device 114, the user input indicating a user selection of how the issuer is to proceed, and may transmit instructions to the respective issuer computing device 110 that cause the issuer to implement the user selection.

In at least some embodiments, ADR computing device 106 monitors compromised PANs and/or performs enhanced authentication on behalf of issuer computing device 110. Specifically, ADR computing device 106 may store the PANs in database 108, which may include a compromised account database 108. Only compromised PANs are stored in this compromised account database 108. Accordingly, ADR computing device 106 monitors all incoming transaction messages (e.g., authorization request messages, account status inquiries, and/or authentication request messages), extracts a subject PAN from each incoming transaction message, and performs a lookup in compromised account database 108 using the subject PAN. If the subject PAN matches any PAN stored in compromised account database 108, ADR computing device 106 may flag the incoming transaction message with a compromise flag before transmitting the transaction message to issuer computing device 110. The compromise flag causes issuer computing device 110 to automatically initiate enhanced authentication of the associated transaction. Additionally or alternatively, ADR computing device 106 automatically performs the enhanced authentication on behalf of issuer computing device 110, and transmits the transaction message to issuer computing device 110 appended with (a) the compromise flag, and (b) the authentication result of the enhanced authentication, such that issuer computing device 110 may use the compromise flag and/or authentication result to determine whether to authorize the transaction (or proceed with another process associated with the transaction message). In some cases, issuer computing device 110 may use these data elements in its own authentication procedures or, where the authentication result indicates the transaction is likely genuine, may forego its own authentication procedures. Moreover, it is contemplated that, in some embodiments, ADR computing device 106 may decline (or cause to be declined) any transaction message associated with a compromised PAN.

In some alternative embodiments, ADR computing device 106 stores the compromised PANs in a more general account database (e.g., an account database 108) that includes both compromised and non-compromised PANs (e.g., with various flags indicating various characteristics of associated PANs). In such cases, ADR computing device 106 may store the compromised PANs with a compromise flag indicating the PANs are compromised. ADR computing device 106 monitors all incoming transaction messages (e.g., authorization request messages, account status inquiries, and/or authentication request messages), extracts a subject PAN from each incoming transaction message, and performs a lookup in account database 108 using the subject PAN. Where the subject PAN matches a PAN with the compromise flag, ADR computing device 106 may initiate enhanced authentication and/or append the compromise flag to the transaction message as described above.

In some embodiments of the present disclosure, the ADR computing may store all PANs having the attack identifier flag, described above, in the general account database 108. In some such cases, ADR computing device 106 may monitor all incoming transaction messages (e.g., authorization request messages, account status inquiries, and/or authentication request messages), extract a subject PAN from each incoming transaction message, and perform a lookup in account database 108 using the subject PAN. Where the subject PAN matches a PAN with the attack identifier flag (but not the compromise flag), ADR computing device 106 may append a different flag to that transaction message, instructing issuer computing device 110 to raise the fraud score for that transaction message, but not necessarily requiring initiation of the enhanced authentication.

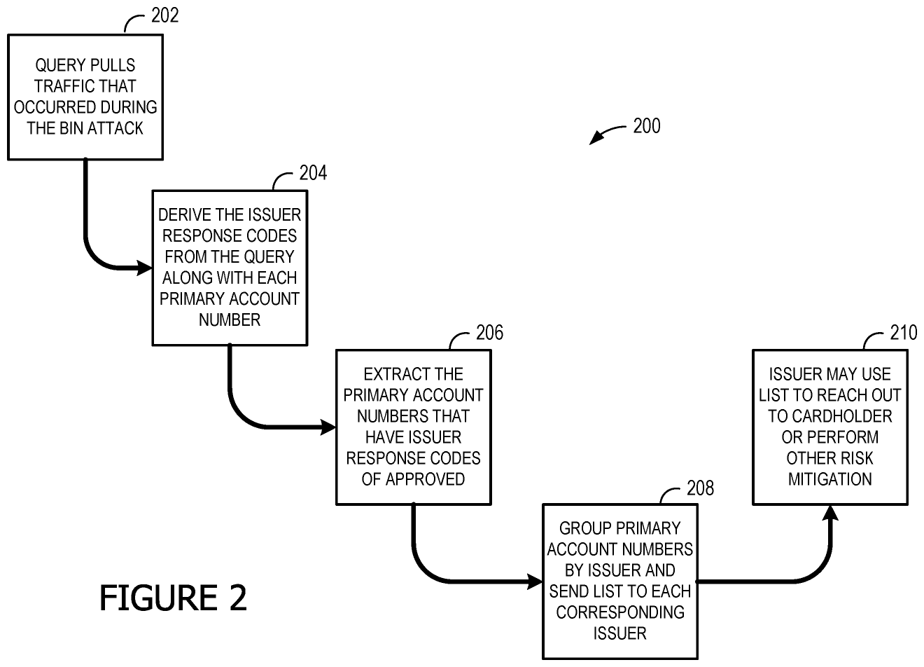

FIG. 2 is a simplified flow diagram illustrating a fraud attack response process 200 implemented using fraud analysis computing system 100 shown in FIG. 1. As shown, after a BIN attack is detected, a query is sent (e.g., to a database such as database 108, shown in FIG. 1) for all transaction traffic that occurred during the BIN attack (step 202). In the example embodiment, this query is generated and transmitted by ADR computing device 106 (shown in FIG. 1) and may include, for example, a start and end time defining a time period of the BIN attack. The query returns transaction records associated with the transaction traffic that occurred during the BIN attack.

ADR computing device 106 derives issuer response codes and primary account numbers (PANs) for each transaction from the returned transaction records (step 204). Thereafter, ADR computing device 106 extracts the PANs associated with transactions that include issuer response codes of “approved” or “authorized”, indicating the attempted (fraudulent) transaction was successful (step 206).

ADR computing device 106 groups these extracted PANs by issuer and transmits respective lists of the extracted PANs to the corresponding issuers (e.g., issuer computing devices 110, shown in FIG. 1) (step 208). Each issuer computing device 110 may then reach out to affected cardholders associated with those PANs and/or may implement other risk mitigation processes, as described elsewhere herein (step 210).

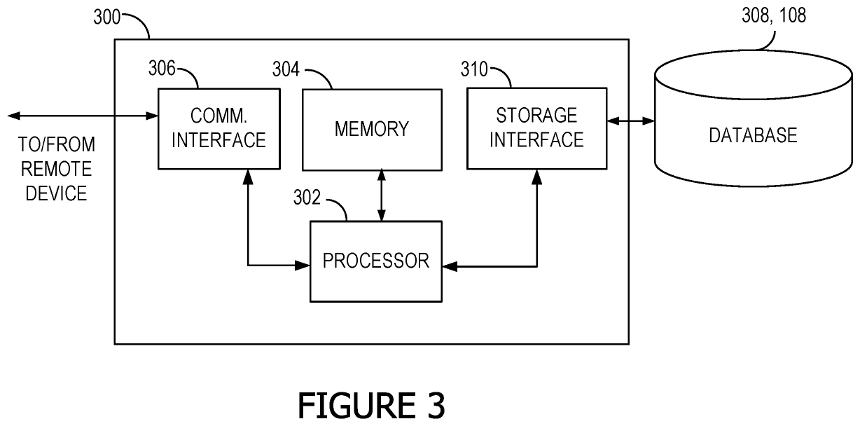

FIG. 3 illustrates an example configuration of a server system 300 that may be used with the fraud analysis computing system 100 shown in FIG. 1. Server system 300 may include, for example, payment processor 104, attack detection and response (ADR) computing device 106, and/or a computing device of merchant 54 (all also shown in FIG. 1).

Server system 300 includes a processor 302 for executing instructions. Instructions may be stored in a memory area 304, for example. Processor 302 may include one or more processing units (e.g., in a multi-core configuration) for executing instructions. The instructions may be executed within a variety of different operating systems on the server system 300, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

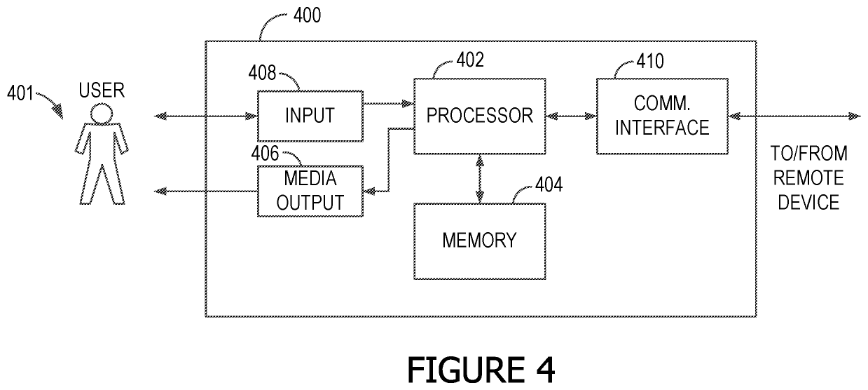

Processor 302 is operatively coupled to a communication interface 306 such that server system 300 is capable of communicating with remote devices such as client systems 400 (shown in FIG. 4) or another server system 300. For example, communication interface 306 may receive requests from a client system 400 via the Internet.

Processor 302 may also be operatively coupled to a storage device 308, which may be used to implement database 108 (shown in FIG. 1). Storage device 308 is any computer-operated hardware suitable for storing and/or retrieving data. In some embodiments, storage device 308 is integrated in server system 300. For example, server system 300 may include one or more hard disk drives as storage device 308. In other embodiments, storage device 308 is external to server system 300 and may be accessed by a plurality of server systems 300. For example, storage device 308 may include multiple storage units such as hard disks or solid state disks in a redundant array of inexpensive disks (RAID) configuration. Storage device 308 may include a storage area network (SAN) and/or a network attached storage (NAS) system.

In some embodiments, processor 302 is operatively coupled to storage device 308 via a storage interface 310. Storage interface 310 is any component capable of providing processor 302 with access to storage device 308. Storage interface 310 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 302 with access to storage device 308.

Memory area 304 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

FIG. 4 illustrates an example configuration of a client system 400 that may be used in fraud analysis computing system 100 (shown in FIG. 1). Client system 400 may include, for example, a computing device of merchant 54, issuer computing device 110, and/or user computing device 114 (all also shown in FIG. 1). Client system 400 may be operated by a user 401. In the example embodiment, client system 400 includes a processor 402 for executing instructions. In some embodiments, executable instructions are stored in a memory area 404. Processor 402 may include one or more processing units, for example, a multi-core configuration. Memory area 404 is any device allowing information such as executable instructions and/or written works to be stored and retrieved. Memory area 404 may include one or more computer readable media.

Client system 400 also includes at least one media output component 406 for presenting information to user 401. Media output component 406 is any component capable of conveying information to user 401. For example, media output component is configured to display a graphical user interface to user 401. In some embodiments, media output component 406 includes an output adapter such as a video adapter and/or an audio adapter. An output adapter is operatively coupled to processor 402 and operatively coupleable to an output device such as a display device, a liquid crystal display (LCD), organic light emitting diode (OLED) display, or “electronic ink” display, or an audio output device, a speaker or headphones.

In some embodiments, client system 400 includes an input device 408 for receiving input from user 401. Input device 408 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 406 and input device 408. Client system 400 may also include a communication interface 410, which is communicatively coupleable to a remote device such as server system 300 (shown in FIG. 3). Communication interface 410 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

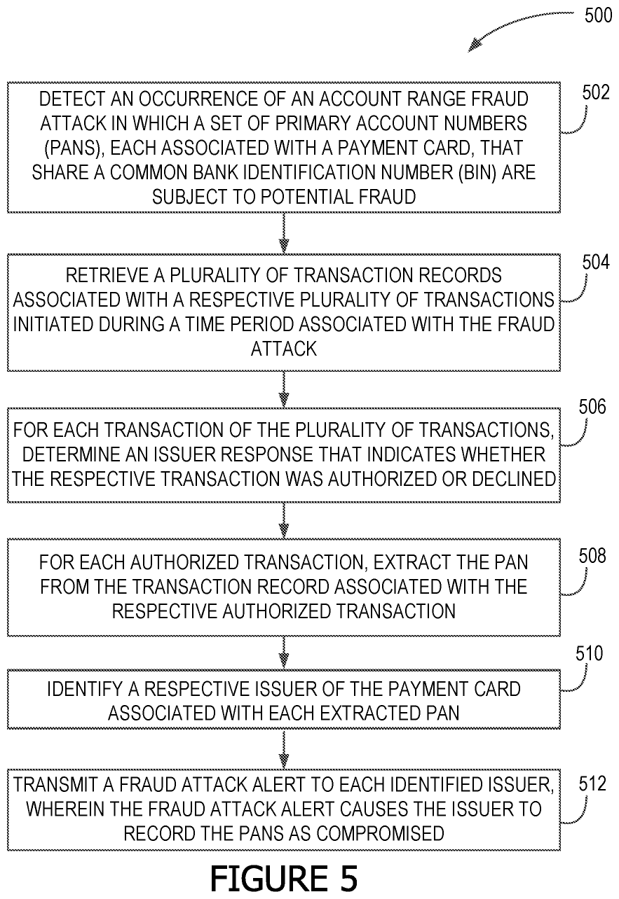

FIG. 5 is a flow diagram of a computer-implemented method 500 for detecting account range fraud attacks in a payment card network. Method 500 is implemented using at least one computing device, such as fraud analysis computing system 100, or, more specifically, attack detection and response (ADR) computing device 106 thereof (both shown in FIG. 1).

Method 500 includes detecting 502 an occurrence of an account range fraud attack in which a set of primary account numbers (PANs), each associated with a respective payment card, that share a common bank identification number (BIN) are subject to potential fraud. Method 500 also includes retrieving 504 a plurality of transaction records associated with a respective plurality of transactions initiated during a time period associated with the fraud attack, and, for each transaction of the plurality of transactions, determining 506 an issuer response that indicates whether the respective transaction was authorized or declined.

Method 500 further includes, for each authorized transaction, extracting 508, the PAN from the transaction record associated with the respective authorized transaction, identifying 510 a respective issuer (e.g., an issuer associated with issuer computing device 110, shown in FIG. 1) of the payment card associated with each extracted PAN, and transmitting 512 a fraud attack alert to each identified issuer. The fraud attack alert identifies (e.g., includes data elements representing) the occurrence of the fraud attack, the time period associated with the fraud attack, and the PANs associated with the authorized transactions. The fraud attack alert causes the issuer to record or flag the PANs as compromised. For example, the fraud attack alert includes instructions, generating by ADR computing device 106, that causes issuer computing device 110 (associated with the issuer) to activate and associate a flag with each of the PANs within the computing system of the issuer (e.g., one or more databases, fraud modeling systems, etc.).

Method 500 may include additional, alternative, and/or fewer steps. For example, in some embodiments, method 500 further includes storing the extracted PANs in a compromised account database (e.g., database 108, shown in FIG. 1) communicatively coupled to the ADR computing device, and for each future incoming authorization request, performing a lookup in the compromised account database to determine whether the authorization request includes any of the stored PANs. Method 500 may also include, when the authorization request includes any of the stored PANs, initiating an enhanced authentication procedure prior to transmitting the authorization request to the respective issuer of payment card associated with the PAN.

In some embodiments, method 500 includes storing the extracted PANs in an account database communicatively coupled to the ADR computing device, and appending a compromise flag to each of the extracted PANs stored in the account database. In some such embodiments, method 500 further includes, for each future incoming authorization request, performing a lookup in the account database to determine whether the authorization request includes any stored PAN having the compromise flag appended thereto. When the authorization request includes any stored PAN having the compromise flag appended thereto, method 500 may further include initiating an enhanced authentication procedure prior to transmitting the authorization request to the respective issuer of the payment card associated with the PAN.

Additionally or alternatively, method 500 may include receiving a real-time stream of all transactions initiated over a payment processing network, and applying artificial intelligence to the real-time stream to detect the fraud attack by detecting anomalously high transaction traffic having the common BIN. In some such embodiments, method 500 may include flagging transactions occurring during the fraud attack with an attack identifier flag. In some cases, retrieving 504 the plurality of transaction records associated with the respective plurality of transactions initiated during the time period associated with the fraud attack includes performing a lookup in a transaction record database using the attack identifier flag. Additionally or alternatively, method 500 may include flagging only transactions occurring during the fraud attack including the common BIN with the attack identifier flag.

As used herein, “machine learning” refers to statistical techniques to give computer systems the ability to “learn” (e.g., progressively improve performance on a specific task) with data, without being explicitly programmed for that specific task. “Artificial intelligence” refers to computer-executed techniques that allow a computer to interpret external data, “learn” from that data, and apply that knowledge to a particular end. Artificial intelligence may include, for example, neural networks used for predictive modeling.

As will be appreciated based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “user computing device” refers to any computing device which is used in a portable manner including, without limitation, smart phones, personal digital assistants (“PDAs”), computer tablets, hybrid phone/computer tablets (“phablet”), or other similar device capable of functioning in the systems described herein. In some examples, user computing devices may include a variety of peripherals and accessories including, without limitation, microphones, speakers, keyboards, touchscreens, gyroscopes, accelerometers, and metrological devices.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computing system for detecting anomalous activity over a computer network, said computing system comprising at least one processor, the at least one processor configured to:
receive a real-time stream of electronic messages, each of the electronic messages including a first identifier, wherein a portion of the first identifier includes a second identifier;
apply a detection model to the real-time stream of electronic messages, wherein the detection model is programmed to apply at least one machine learning algorithm trained to detect, within the real-time stream, that a velocity of the electronic messages for a range of first identifiers having a common value second identifier exceeds a threshold;
in response to detecting that the velocity of the electronic messages for the range of first identifiers having the common value second identifier exceeds the threshold, identify a time period associated with anomalous activity; and
append an anomalous activity flag to messages initiated during the time period associated with anomalous activity which include a first identifier having the common value in the second identifier.

2. The computing system of claim 1, wherein the at least one processor is further configured to:
detect that a first identifier in a subsequent real-time electronic message matches a first identifier that has been flagged; and
based on the detection, automatically initiate an enhanced authentication procedure prior to transmitting the subsequent real-time electronic message to a respective issuer.

3. The computing system of claim 1, wherein the anomalous activity flag indicates fraudulent activity.

4. The computing system of claim 1, wherein the electronic messages comprise authorization messages.

5. The computing system of claim 1, wherein the at least one processor is further configured to store the first identifiers associated with flagged electronic messages in an anomalous activity database communicatively coupled to the at least one processor.

6. The computing system of claim 5, wherein the at least one processor is further configured to:
query the anomalous activity database to retrieve a plurality of electronic messages initiated during the time period associated with anomalous activity and for which the first identifier has the common value in the second identifier portion;
extract the first identifier from each of the retrieved electronic messages for which an issuer response code indicates am associated transaction was authorized;
identify a respective issuer associated with each extracted first identifier having the common value in the second identifier portion;
generate an anomalous activity alert that identifies each extracted first identifier; and
transmit the anomalous activity alert to a respective issuer computing device.

7. The computing system of claim 6, wherein the anomalous activity alert further comprises instructions which cause the issuer computing device to append a flag to each extracted PAN in an issuer database coupled to the issuer computing device.

8. The computing system of claim 7, wherein the instructions cause each identified issuer to issue a new first identifier to replace the first identifiers associated with the authorized transactions.

9. A computer-implemented method for detecting anomalous activity over a computer network, the method implemented using at least one processor, the method comprising:
receiving a real-time stream of electronic messages, each of the electronic messages including a first identifier, wherein a portion of the first identifier includes a second identifier;
applying a detection model to the real-time stream of electronic messages, wherein the detection model is programmed to apply at least one machine learning algorithm trained to detect, within the real-time stream, that a velocity of the electronic messages for a range of first identifiers having a common value second identifier exceeds a threshold;
in response to detecting that the velocity of the electronic messages for the range of first identifiers having the common value second identifier exceeds the threshold, identifying a time period associated with anomalous activity; and
appending an anomalous activity flag to messages initiated during the time period associated with anomalous activity which include a first identifier having the common value in the second identifier.

10. The computer-implemented method of claim 9, further comprising:
detecting that a first identifier in a subsequent real-time electronic message matches a first identifier that has been flagged; and
based on the detection, automatically initiating an enhanced authentication procedure prior to transmitting the subsequent real-time electronic message to a respective issuer.

11. The computer-implemented method of claim 9, wherein the anomalous activity flag indicates fraudulent activity.

12. The computer-implemented method of claim 9, wherein the electronic messages comprise authorization messages.

13. The computer-implemented method of claim 9, further comprising storing the first identifiers associated with flagged electronic messages in an anomalous activity database communicatively coupled to the at least one processor.

14. The computer-implemented method of claim 13, further comprising:
querying the anomalous activity database to retrieve a plurality of electronic messages initiated during the time period associated with anomalous activity and for which the first identifier has the common value in the second identifier portion;
extracting the first identifier from each of the retrieved electronic messages for which an issuer response code indicates am associated transaction was authorized;
identifying a respective issuer associated with each extracted first identifier having the common value in the second identifier portion;
generating an anomalous activity alert that identifies each extracted first identifier; and
transmitting the anomalous activity alert to a respective issuer computing device.

15. A non-transitory computer-readable storage medium including computer-executable instructions stored thereon, wherein when executed by a processor, the computer-executable instructions cause the processor to:
receive a real-time stream of electronic messages, each of the electronic messages including a first identifier, wherein a portion of the first identifier includes a second identifier;
apply a detection model to the real-time stream of electronic messages, wherein the detection model is programmed to apply at least one machine learning algorithm trained to detect, within the real-time stream, that a velocity of the electronic messages for a range of first identifiers having a common value second identifier exceeds a threshold;
in response to detecting that the velocity of the electronic messages for the range of first identifiers having the common value second identifier exceeds the threshold, identify a time period associated with anomalous activity; and
append an anomalous activity flag to messages initiated during the time period associated with anomalous activity which include a first identifier having the common value in the second identifier.

16. The non-transitory computer-readable storage medium of claim 15, wherein the computer-executable instructions further cause the processor to:
detect that a first identifier in a subsequent real-time electronic message matches a first identifier that has been flagged; and
based on the detection, automatically initiate an enhanced authentication procedure prior to transmitting the subsequent real-time electronic message to a respective issuer.

17. The non-transitory computer-readable storage medium of claim 15, wherein the anomalous activity flag indicates fraudulent activity.

18. The non-transitory computer-readable storage medium of claim 15, wherein the electronic messages comprise authorization messages.

19. The non-transitory computer-readable storage medium of claim 15, wherein the computer-executable instructions further cause the processor to store the first identifiers associated with flagged electronic messages in an anomalous activity database communicatively coupled to the processor.

20. The non-transitory computer-readable storage medium of claim 19, wherein the computer-executable instructions further cause the processor to:
query the anomalous activity database to retrieve a plurality of electronic messages initiated during the time period associated with anomalous activity and for which the first identifier has the common value in the second identifier portion;
extract the first identifier from each of the retrieved electronic messages for which an issuer response code indicates am associated transaction was authorized;
identify a respective issuer associated with each extracted first identifier having the common value in the second identifier portion;
generate an anomalous activity alert that identifies each extracted first identifier; and
transmit the anomalous activity alert to a respective issuer computing device.
